(19) United States
(12) Patent Application Publication
(10) Pub. No.: US 2019/0129673 A1
(43) Pub. Date: May 2, 2019

(54) DATA DISPLAY METHOD, DATA DISPLAY PROGRAM, COMMUNICATION SYSTEM, AND INFORMATION PROCESSING TERMINAL

(71) Applicant: LINE Corporation, Tokyo (JP)

(72) Inventor: Sotaro II, Tokyo (JP)

(73) Assignee: LINE Corporation, Tokyo (JP)

(21) Appl. No.: 16/232,449

(22) Filed: Dec. 26, 2018

Related U.S. Application Data
(63) Continuation of application No. PCT/JP2017/009314, filed on Mar. 8, 2017.

(30) Foreign Application Priority Data
Jun. 22, 2016 (JP) 2016-123528

(51) Int. Cl. G06F 3/14; G06F 3/0484

(52) U.S. Cl. CPC G06F 3/14; H04L 67/42; G06F 3/04847

(57) ABSTRACT

Use of the communication system is made comfortable. A method includes receiving identification information of a transmitter; acquiring data corresponding to identification information of a group to which a transmitter belongs received from information processor for transmitting data corresponding to identification information of a group set as a group configured by a plurality of transmitters; accepting designation of a group of transmitters in which display of received data is restricted according to an operation by a user; determining, if a group in which display of data is restricted is not designated for the transmitter identified by the newly received identification information, data corresponding to identification information of the group is to be displayed; and displaying on a display the data corresponding to the identification information of the group if the data is determined to be displayed.

### CROSS REFERENCE TO RELATED APPLICATION(S)

This U.S. non-provisional application is a continuation application of, and claims the benefit of priority under 35 U.S.C. § 365(c) from, PCT International Application PCT/JP2017/009314, filed Mar. 8, 2017, which claims priority to Japanese Application No. 2016-123528, filed Jun. 22, 2016, the entire contents of each of which are incorporated herein by reference.

### BACKGROUND

Various example embodiments of the present disclosure relate to a data display method, a data display program, a communication system, and/or an information processing terminal for restricting display of data to be received.

The diversification of applications in terminal devices such as smart phones (hereinafter, referred to as “information processing terminals”) has spread various services via the terminal devices in recent years. For example, a message application (hereinafter, referred to as “message app”) embodies a messaging service for chatting and/or exchanging messages between information processing terminals of a plurality of users via a network. In this message app, the user receives a message from, for example, a company that provides a service of a clothing grocery store, a restaurant, a movie theater, and a hospital, etc., (hereinafter also referred to as “shops”), allowing the user to receive various types of information such as products and coupons distributed by the shops in a message form on the information processing terminal. It is also common that the function of the message app is provided in a manner integrated with a social networking service (SNS).

A transmitter of the shops distributes a large amount of data. In addition, a number of transmitters may be installed in the shops, and the transmitters distribute data. Further, the transmitters arranged in the same shop may distribute the same or similar data. In this case, the information processing terminal receives the data a plurality of times, which may include the same or similar data. This may increase the number of data to be displayed on the information processing terminal, and the same or similar data may be displayed a plurality of times. Accordingly, the user may be forced to check data that is not needed to view, which may decrease the comfort of using the communication system or causes unnecessary communication to occur.

As described above, in recent years in which a plurality of data are transmitted and received between the terminals, browsing and checking of data may be a burden to the user, and thus it is a problem to reduce the burden on the user (for example, please refer to patent documents 1 and 2).

### Patent Documents

[Patent Document 1] Japanese Laid-Open Patent Publication No. 2007-188239
[Patent Document 2] Japanese Laid-Open Patent Publication No. 2010-176248

### SUMMARY

As described above, when a plurality of data having the same or similar contents are displayed on the information processing terminal, the user is forced to check unnecessary data. This may cause the user to less comfortably use the communication system.

It is therefore an object of the present disclosure to provide a data display method, a data display program, a communication system, and an information processing terminal that can be comfortably used by a user.

A data display method in an information processing terminal according to at least one example embodiment includes the steps of: a receiving step for receiving transmitter identification information of a transmitter from the transmitter; a transmitting step for transmitting the transmitter identification information to an information processor; an acquiring step for acquiring data associated with the transmitter identification information from the information processor; a displaying step for displaying, if display of data associated with transmitter identification information newly received from the transmitter or the transmitter identification information received from the information processor is not designated to be restricted, data corresponding to the transmitter identification information; and an accepting step for accepting designation for restricting display of the data in response to an operation by a user.

The data may be associated with two or more pieces of the transmitter identification information.

The transmitting step may include transmitting the transmitter identification information and a port number or an IP address associated with the information processing terminal.

In the accepting step, the designation for restricting display of the data according to an operation by a user may designate a group associated with the transmitter identification information.

The data display method may further include: a first registering step for registering a group associated with the transmitter identification information designated in the accepting step as a non-display target. In the displaying step, as transmitter identification information of the transmitter is newly received in the receiving step, the data associated with the transmitter identification information may be displayed if a group associated with the transmitter identification information of the transmitter is not included in the non-display target.

The data display method may further include an updating step for updating the non-display target to cancel the restriction of display of a group after the group in which the display is restricted is designated in the accepting step.

The data display method may further include: a second registering step for registering a group corresponding to data as display history data when the data is displayed in the displaying step. As transmitter identification information is newly received, data associated with the transmitter identification information may be displayed if a group associated with the transmitter identification information is not included in the display history data.

The display history data may further include a display time at which the data is displayed. Even if the group is included in the non-display target, in a case where a predetermined time has elapsed from a display time at which data corresponding to the group is displayed, the data corresponding to the group may be displayed.

The data display method may further include a determining step for determining, as transmitter identification information is newly received, whether an operation related to data associated with the transmitter identification information is included in operation history data as an operation history of the user.

A data display program according to at least one example embodiment causes an information processing terminal to perform: a receiving function of receiving transmitter identification information of a transmitter from the transmitter; a transmitting function of transmitting the transmitter identification information to an information processor; an acquiring function of acquiring data associated with the transmitter identification information from the information processor; a displaying function of displaying, if a group in which display is restricted is not designated for data associated with transmitter identification information newly received from the transmitter or the transmitter identification information received from the information processor, the data corresponding to the transmitter identification information; and an accepting function of accepting designation for restricting display of the data in response to an operation by a user.

A data communication system according to at least one example embodiment includes: a transmitter having a transmission unit for transmitting identification information of an own device; an information processor having a transmission processor for transmitting data corresponding to identification information of a group set as a group configured by a plurality of transmitters according to a request; a receiver for receiving transmitter identification information of the transmitter from the transmitter; the transmission unit for transmitting the transmitter identification information to the information processor; an acquisition unit for acquiring data associated with the transmitter identification information from the information processor; a display processor for displaying, if a group in which display of data is restricted is not designated for data associated with transmitter identification information newly received from the transmitter or the transmitter identification information received from the information processor, the data corresponding to the transmitter identification information; and an information processing terminal having an acceptance unit for accepting designation for restricting display of the data in response to an operation by a user.

The information processing terminal may further include: a first register for registering identification information of the group designated by the acceptance unit as non-display data; and a first determination unit for determining, if a group in which display of data is restricted is not designated for the transmitter identified by the newly received transmitter identification information, data corresponding to identification information of the group is to be displayed.

The information processing terminal may further include: a notifier for notifying the information processor of the identification information of the group designated by the acceptance unit, and the information processor may include a registration processor for registering identification information of a group received from the information processing terminal as well as identification information of the information processing terminal as non-display data. In a case where a request signal is newly received from the information processing terminal, if the transmitter identified by the identification information included in the request signal is not included in the group in which the identification information is registered in the non-display data, the data may be transmitted.

An information processing terminal according to at least one example embodiment includes: a receiving unit for receiving transmitter identification information of a transmitter from the transmitter; a transmitting unit for transmitting the transmitter identification information to an information processor; an acquisition unit for acquiring data associated with the transmitter identification information from the information processor; a display processor for displaying, if data associated with transmitter identification information newly received from the transmitter or the transmitter identification information received from the information processor is not designated to restrict display, the data corresponding to the transmitter identification information; and an acceptance unit for accepting designation for restricting display of the data according to an operation by a user.

### Advantageous Effects of Invention

The present invention can provide a communication system and an information processing terminal that reduce opportunities for a user to browse the same or similar data and the trouble of the user so that the user can use them comfortably.

### BRIEF DESCRIPTION OF THE DRAWINGS

FIG. 1 is a block diagram illustrating a configuration of a communication system according to an example embodiment.

FIG. 2 is a schematic diagram illustrating a communication method according to an example embodiment.

FIG. 3 is an example of data used in the communication method according to an example embodiment.

FIG. 4 is a sequence diagram illustrating the communication method according to an example embodiment.

FIG. 5 is a sequence diagram illustrating a communication method according to another example embodiment.

FIG. 6 is a sequence diagram illustrating a communication method according to another example embodiment.

FIG. 7 is a sequence diagram illustrating a communication method according to another example embodiment.

FIG. 8 is a sequence diagram illustrating a communication method according to another example embodiment.

FIG. 9 is a block diagram illustrating a configuration of a communication system according to another example embodiment.

### DETAILED DESCRIPTION

Hereinafter, a data display method, data display program, communication system, and/or information processing terminal according to at least one example embodiment will be described with reference to the drawings. The data display method according to at least one example embodiment will be described as a method of controlling the display of data received according to the use of the user when the information processing terminal registered in the messaging service receives the data transmitted from the beacon transmitter. Also, a data display program is directed to a software program, stored on a non-transitory computer readable medium, executed by the information processing terminal. Further, the communication system includes a server, a beacon transmitter, and/or an information processing terminal, and is directed to a system that controls the display of data in the information processing terminal.

### <Communication System>

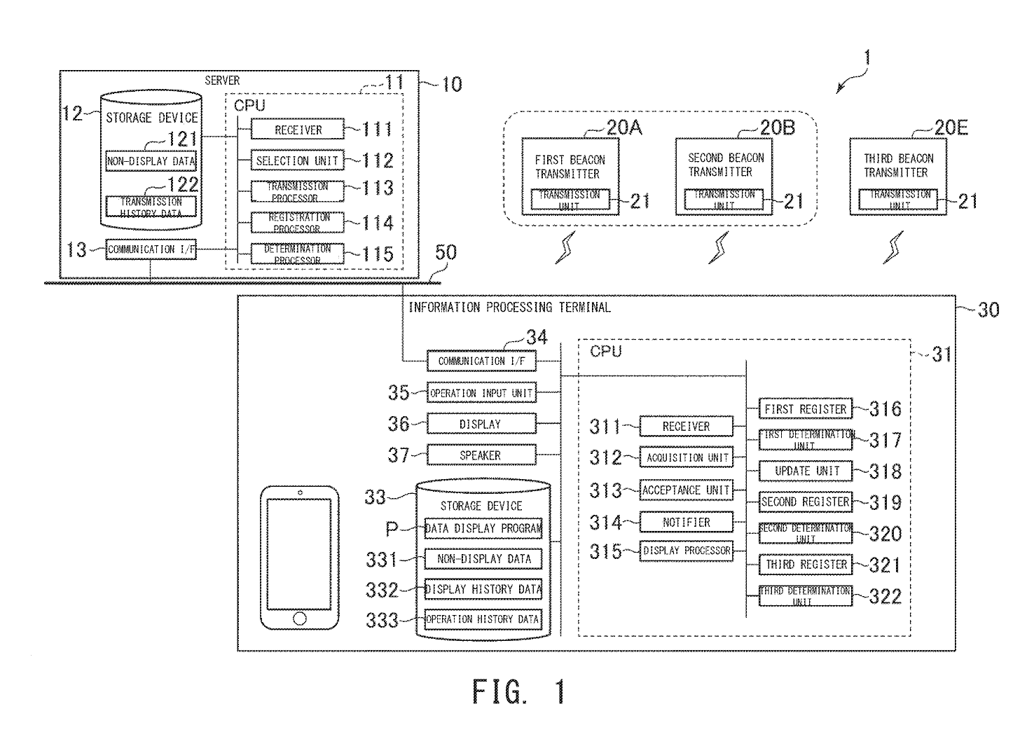

As shown in FIG. 1, a communication system 1 includes a server 10, a plurality of beacon transmitters 20 (20A, 20B, . . . , 20E), and an information processing terminal 30. The server 10 and the information processing terminal 30 are connected via a network 50 such as the Internet. Although FIG. 1 shows only three beacon transmitters 20A, 20B and 20C, the number of the beacon transmitters 20 included in the communication system 1 is not limited. Also, although FIG. 1 shows only a single information processing terminal 30, the number of information processing terminals included in the communication system 1 is not limited.

The network 50 serves to connect one or more information processing terminals 30 with the information processing apparatus 10. That is, the network 50 is directed to a communication network that provides a connection path that allows the information processing terminal 30 to transmit and receive data after connecting to the information processing apparatus 10. The network 50 may be a wired network such as local area networks (LANs), wide area networks (WANs), metropolitan area networks (MANs), integrated service digital networks (ISDNs), and/or a wireless network such as wireless LANs, code division multiple access (CDMA), Bluetooth (registered trademark), and satellite communication though the scope of the example embodiments are not limited thereto.

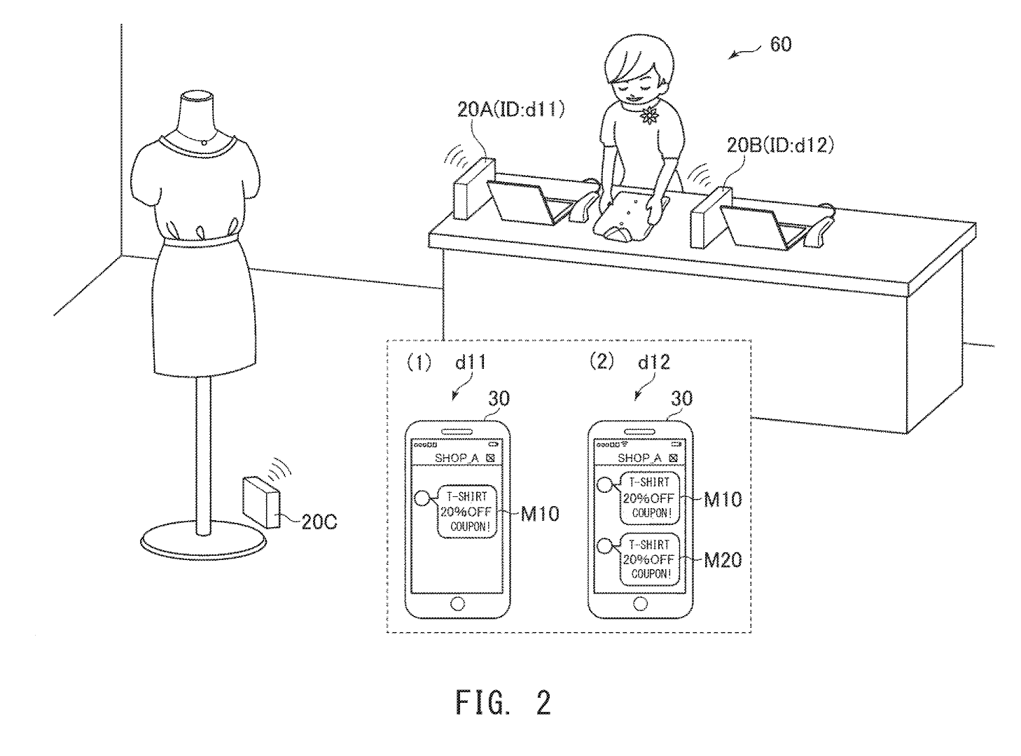

The outline of the processing in the communication system 1 will be described with reference to FIG. 2. In the communication system 1, the information processing terminal 30 receives and displays data distributed by the beacon transmitter 20. A plurality of beacon transmitters 20A to 20C are installed in the shop 60 that performs data distribution using the communication system 1. Here, each of the beacon transmitters 20A to 20C belongs to the same first group. Also, each of the beacon transmitters 20A to 20C uses the same “account ID.” Further, it is assumed that the beacon transmitters 20A to 20C belonging to the first group distribute data having the same contents. At this time, the beacon transmitter 20 can transmit “transmitter ID” for identifying the own device, not the data itself.

In FIG. 2, the ID of the first beacon transmitter 20A is “d11” and the ID of the second beacon transmitter 20B is set to “d12.” Also, the first beacon transmitter 20A transmits “d11” as transmission data. Further, the second beacon transmitter 20B transmits “d12” as transmission data.

Upon receiving the “d11” from the first beacon transmitter 20A, the information processing terminal 30 acquires data corresponding to the “d11” from the server 10, and displays, as shown in (1) in FIG. 2, the acquired data on the display unit M10. Next, when the information processing terminal 30 receives the “d22” from the second beacon transmitter 20B, it acquires data corresponding to the “d12” from the server 10, and displays, as shown in (2) in FIG. 2, the data on the display unit M20.

As described above, the first beacon transmitter 20A and the second beacon transmitter 20B belong to the same group. That is, the same group distributes the same data. Accordingly, the data corresponding to the “d11” and the data corresponding to the “d12” are the same. Therefore, as shown in (2) in FIG. 2, the information processing terminal 30 displays the same data a plurality of times. Further, upon receiving the data, the information processing terminal 30 notifies the user of reception by sound or vibration, but when the reception is notified a number of times, the user is forced to check the data received by the information processing terminal 30 each time and act unnecessarily.

The method of displaying data on the information processing terminal 30 is not limited to the example shown in FIG. 2. That is, although FIG. 2 shows the example in which the data displayed based on the “d11” received from the first beacon transmitter 20A and the data displayed based on the “d12” received from the second beacon transmitter 20B are included in a single screen and displayed, the example embodiment is not limited to the example.

Accordingly, in the communication system 1, if the information processing terminal 30 restricts the display of data corresponding to the beacon transmitters of the same group after the data is once displayed, the information processing terminal 30 can designate that the data distributed from the beacon transmitters of the designated group is not displayed and notified after the data is once displayed.

### <Beacon Transmitter>

Each beacon transmitter 20 includes a transmission unit 21 that transmits “identifier for identifying the own device” or “data to be distributed” as transmission data. The beacon transmitter 20 transmits the transmission data using a standard related to short-distance wireless communication such as wireless LAN, infrared, and Bluetooth (registered trademark), for example. Further, the data to be distributed may include, for example, information on products sold or provided by a shop, discount coupon data, point granting data, content data such as a stamp used in a messaging service, and/or data used for adding friends, etc.

The beacon transmitter 20 is disposed in a shop, for example. In addition, the data transmitted by the beacon transmitter 20 is present within a predetermined area with respect to the beacon transmitter 20, and received by a device having a communication interface of the same communication standard. Specifically, the data transmitted by the beacon transmitter 20 is received by the information processing terminal 30 possessed by the user existing around the beacon transmitter 20 during the period when the user is present at a shop, for example.

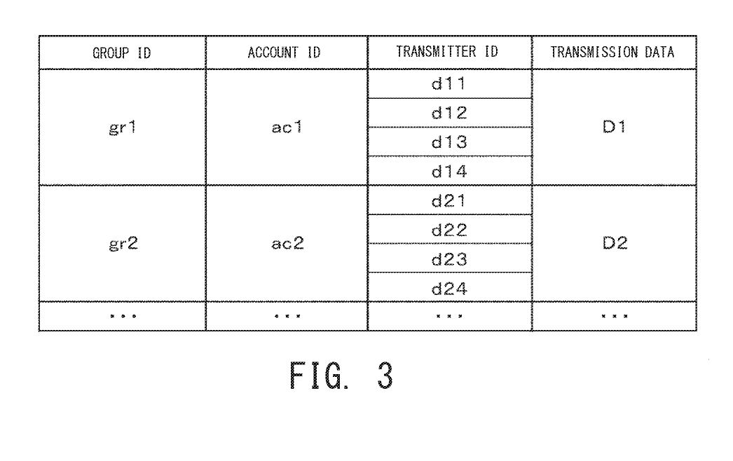

Hereinafter, the identifier of the data transmitted by each beacon transmitter 20 is defined as “transmitter ID.” Further, the “transmitter ID” transmitted by each beacon transmitter 20 is associated with “transmission data” which is directed to data to be distributed, as will be described later with reference to FIG. 3. The “transmission data” may be data for displaying data on the display in the information processing terminal 30 that receives the transmission data, or an identifier (for example, URL) of data displayed on the display.

As described above, in the communication system 1, groups are formed by a plurality of beacon transmitters 20. Here, it is assumed that the “transmitter ID” transmitted from the beacon transmitters 20 belonging to the same group are associated with the same “transmission data.” Further, it is assumed that the transmitters 20 belonging to the same group use the same “account ID” in the communication system 1. In the communication system 1, “group ID” may be used in place of the “account ID.” Further, the “account ID” may be regarded as “group ID.”

In the example shown in FIG. 1, it is assumed that the first beacon transmitter 20A and the second beacon transmitter 20B belong to the first group as the same group. Also, it is assumed that the third beacon transmitter 20E does not belong to the first group. The number of beacon transmitters 20 included in each group is not limited.

### <Server>

The server 10 is directed to an information processor including a central processing unit (CPU) 11, a storage device 12, and a communication interface (communication I/F) 13, for example. The server 10 stores the transmitter ID as an identifier of the beacon transmitter 20 and the account ID used by each beacon transmitter 20 in the storage device 12 in association with each other. Further, the server 10 stores each account ID and information of display data to be displayed on the display of the information processing terminal 30 in the storage device 12 in association with each other. Accordingly, as the server 10 receives a request signal including the transmitter ID transmitted from the information processing terminal 30, the data corresponding to the transmitter ID can be specified and transmitted to the information processing terminal 30.

For example, as shown in FIG. 3, the storage device 12 stores data associating the “group ID”, “account ID”, “transmitter ID”, and “transmission data.” In the data shown in FIG. 3, the transmitters identified by transmitter IDs “d11”, “d12”, “d13” and “d14” belong to the group with the group ID “gr1,” and specify that the account ID “ac1” is given. Further, the data shown in FIG. 3 corresponds to the transmitter IDs “d11” to “d14”, and the server 10 specifies that the transmission data “D1” is transmitted to the information processing terminal 30. Here, the transmission data “D1” and “D2” may be display data to be displayed on the display in the information processing terminal 30, or an identifier (for example, URL) of display data for specifying data that can be displayed on the display.

The CPU 11 of the server 10 executes processes as a receiver 111, selection unit 112, transmission processor 113, registration processor 114, and determination processor 115.

The receiver 111 receives the request signal transmitted from the information processing terminal 30. The request signal includes a transmitter ID and identification information of the information processing terminal 30 as the source of the request signal.

The selection unit 112 selects the data to be transmitted from the storage device 12 according to the request signal received by the receiver 111. Specifically, the selection unit 112 selects data associated with the transmitter ID included in the request signal.

The transmission processor 113 transmits the data selected by the selection unit 112.

In addition, the receiver 111 receives a non-display request signal from the information processing terminal 30. The non-display request signal contains the group ID or transmitter ID, and the ID of the information processing terminal 30 as the source of the non-display request signal.

The registration processor 114 associates the group ID or transmitter ID included in the non-display request signal received by the receiver 111 with the ID of the information processing terminal 30, and stores it in the storage device 12 as non-display data 121. The non-display data 121 is directed to data for identifying the group to which the beacon transmitter 20 that the information processing terminal 30 restricts the display of data belongs.

When the non-display data 121 is stored in the storage device 12, the determination processor 115 can determine whether the ID of the information processing terminal 30 included in the request signal newly received by the receiver 111 is included in the non-display data. Further, when the ID of the information processing terminal 30 is included in the non-display data 121, the determination processor 115 can determine whether the ID of the group to which the transmitter of the transmitter ID included in the request signal belongs is included in the non-display data 121. Alternatively, the determination processor 115 can determine whether the group ID included in the request signal is included in the non-display data 121. If the determination processor 115 determines that the group ID is not included in the non-display data 121, the determination processor 115 can determine that the data is to be displayed.

The register 114 associates the group ID corresponding to the data transmitted by the transmission processor 113 with the ID of the information processing terminal 30 that has transmitted the data, and stores them in the storage device 12 as transmission history data 122. The transmission history data 122 is directed to data for restricting the display of the same data a plurality of times by the information processing terminal 30.

When the transmission history data 122 is stored in the storage device 12, the determination processor 115 can determine whether the ID of the information processing terminal 30 included in the request signal newly received by the receiver 111 is included in the transmission history data. Further, when the transmission history data 122 includes the ID of the information processing terminal 30, the determination processor 115 can determine whether the ID of the group to which the transmitter of the transmitter ID included in the request signal belongs is included in the transmission history data 122. Alternatively, the determination processor 115 can determine whether the group ID included in the request signal is included in the transmission history data 122. If the determination processor 115 determines that the group ID is not included in the transmission history data 122, the determination processor 115 can determine that the data is to be displayed. That is, it is possible to restrict the retransmission of already transmitted data.

Here, in the case where the determination processing is executed by the determination processor 115, the determination processor 115 transmits data only when the determination processor 115 determines that the data is to be displayed, and the determination processor 115 does not transmit the data when the determination processor 115 determines that the data is not to be displayed.

### <Information Processing Terminal>

The information processing terminal 30 is directed to a terminal allowing the user to use the messaging service. It is assumed that a messaging app is installed on the information processing terminal 30. In the case where the messaging service is used, when the information processing terminal 30 receives data as a message, it notifies the user by sound or vibration and displays the data on the display 36.

With reference to FIG. 1, the configuration of the information processing terminal 30 will be described. The information processing terminal 30 is directed to a terminal including a central processing unit (CPU) 31, a storage device 33, a communication interface (I/F) 34, an operation input unit 35, a display 36, and a speaker 37, for example. The information processing terminal 30 is registered in the messaging service provided by the server 10, stores the display program P (e.g., software program including computer readable instructions) in the storage device 33, and executes the display program P to allow the CPU 31 to serve as a receiver 311, an acquisition unit 312, a acceptance unit 313, a notifier 314, a display processor 315, a first register 316, a first determination unit 317, an update unit 318, a second register 319, a second determination unit 320, a third register 321, and a third determination unit 322. That is, the display program P stored in the storage device 33 allows the information processing terminal 30 to embody the receiving function, the acquisition function, the acceptance function, the notification function, the display processing function, the first registration function, the first determination function, the update function, the second registration function, the second determination function, the third registration function, and the third determination function. Although FIG. 1 does not show the messaging app, the display program P may be a part of the messaging app.

The communication I/F 34 executes transmission and reception of data via the network 50. Further, the communication I/F 34 executes reception of the beacon data transmitted by each beacon transmitter 20. The transmission and reception of the data via the network 50 and the reception of the beacon data transmitted by the beacon transmitter 20 are executed by different units since different communication standards are used. However, in the following description, for the sake of convenience, it is assumed that the communication I/F 34 executes both communication with the server 10 and communication with the beacon transmitter 20.

The operation input unit 35 is directed to a unit used by the user for inputting operation signals, such as operation buttons and touch panels. The operation input unit 35 can enter data and operation signals used for executing the messaging app, for example, and can also enter operation signals for using other services using the network 50, for example.

The display 36 is directed to a unit for outputting text data and image data needed for the information processing terminal 30, such as a liquid crystal display. The speaker 37 is used for outputting audio data. In addition, the information processing terminal 30 may include a microphone, a camera, and a haptic feedback device for providing vibration feedback, for example.

The receiver 311 receives the data transmitted from the beacon transmitter 20. The data corresponds to the “transmitter ID” as described above. Alternatively, the data may correspond to data including the “transmission data,” “transmitter ID,” and “group ID.” In the following description, when the data received from the beacon transmitter 20 includes only the “transmitter ID,” the received data is set as “first data.” Also, when the data received from the beacon transmitter 20 includes the “transmitter ID” and “group ID”, the received data is set as “second data.”

When the data received by the receiver 311 corresponds to the first data, the acquisition unit 312 acquires data corresponding to the transmitter ID from the server 10. To acquire the data, the acquisition unit 312 transmits a request signal including the transmitter ID to the server 10. The request signal also includes identification information of the information processing terminal 30 for the server 10 to identify the information processing terminal 30. The identification information is, for example, an IP address or a port number used by the information processing terminal 30, and is referred to as “terminal ID” in the following description.

The acceptance unit 313 accepts the designation of the group corresponding to the beacon transmitter 20 in which notification and display of received data is restricted according to the operation of the user.

When the receiver 311 receives the data, the notifier 314 can notify the user of the reception of the data by generating sound and the vibration.

The display processor 315 displays data corresponding to the data received by the receiver 311 on the display 36. Here, the display processor 315 sets the data determined to be displayed by the determination units 317, 320, and 322 as data to be displayed.

The first register 316 registers the ID of the group designated by the acceptance unit 313 as non-display data 331 in the storage device 33. That is, the non-display data 311 is directed to data including IDs of groups corresponding to non-display data. In addition, the non-display data 311 includes time information in which non-display is registered.

As the receiver 311 newly receives the first data or the second data, the first determination unit 317 determines whether the beacon transmitter 20 that has transmitted the data is designated as a group in which notification and display are restricted, and if the display is not restricted, the first determination unit 317 determines that the data is to be displayed. Specifically, if the transmitter ID included in the received data is included in the non-display data 331, the first determination unit 317 determines that the beacon transmitter 20 is designated to belong to a group in which the display is restricted. Further, if the beacon transmitter 20 is not designated to belong to a group in which the display is restricted, the first determination unit 317 determines that the data corresponding to the ID of the group to which the beacon transmitter 20 identified by the received transmitter ID belongs is to be displayed.

After the ID of the group in which display is restricted is designated by the acceptance unit 313 and a predetermined time elapses, the update unit 318 deletes the ID of the group to update the non-display data 331. That is, based on the time information of the non-display data 311, the update unit 318 deletes the group ID from the non-display data 311 after the non-display is designated by the user and a predetermined time (for example, 24 hours, etc.) elapses. Accordingly, even if the non-display is designated, the non-display is not continued indefinitely.

As the data is displayed by the display processor 314, the second register 319 registers the group ID corresponding to the displayed data as the display history data 332. In addition, the display history data 332 includes the display time at which the data is displayed.

As the second determination unit 320 newly receives the first data or the second data, it determines whether the ID of the group to which the beacon transmitter 20 that has transmitted the data belongs is included in the display history data 332, and determines that the data is to be displayed if the ID is not included in the display history data 332.

In addition, the second determination unit 320 determines that the data is to be displayed if a predetermined time elapses from the display time at which the data has been previously displayed, even in the case where the group ID is included in the non-display data 331. Alternatively, the update unit 318 may delete the group ID from the display history data 332 after the group ID is registered in the display history data 322 or at the timing when the predetermined time elapses after the data has been previously displayed.

The third register 321 stores, as operation history data 333, a history relating to a predetermined operation entered by the user via the operation input unit 35. For example, the operation history may include a browsing history of a Web page, a purchase history of a product using the Internet, and a friend registration history in which other users and shops, for example, are registered as “friends” in the messaging service. Here, the operation “registered as friend” allows specific data to be transmitted and received, and displayed in the messaging service, for example.

As the first data or the second data is newly received, the third determination unit 322 determines whether the operation related to the data associated with the group to which the beacon transmitter 20 that has transmitted the data belongs is included in the operation history data of the past operation by the user. Further, the third determination unit 322 determines whether the data is to be displayed based on whether the operation is included in the operation history data.

At this time, the operation history data 333 may include the time when the operation is performed, and the third determination unit 322 may use the time for the determination as to whether a predetermined time has elapsed from the operation time. Alternatively, for the specific history, the update unit 318 may delete the group ID from the operation history data 333 at the timing when a predetermined time elapses after the registration in the operation history data 333. For example, the third determination unit 322 may determine whether specific data is to be displayed or not to be displayed within a predetermined time after browsing a specific Web page.

### <First Example Embodiment (Determine Restriction of Display in Information Processing Terminal)>

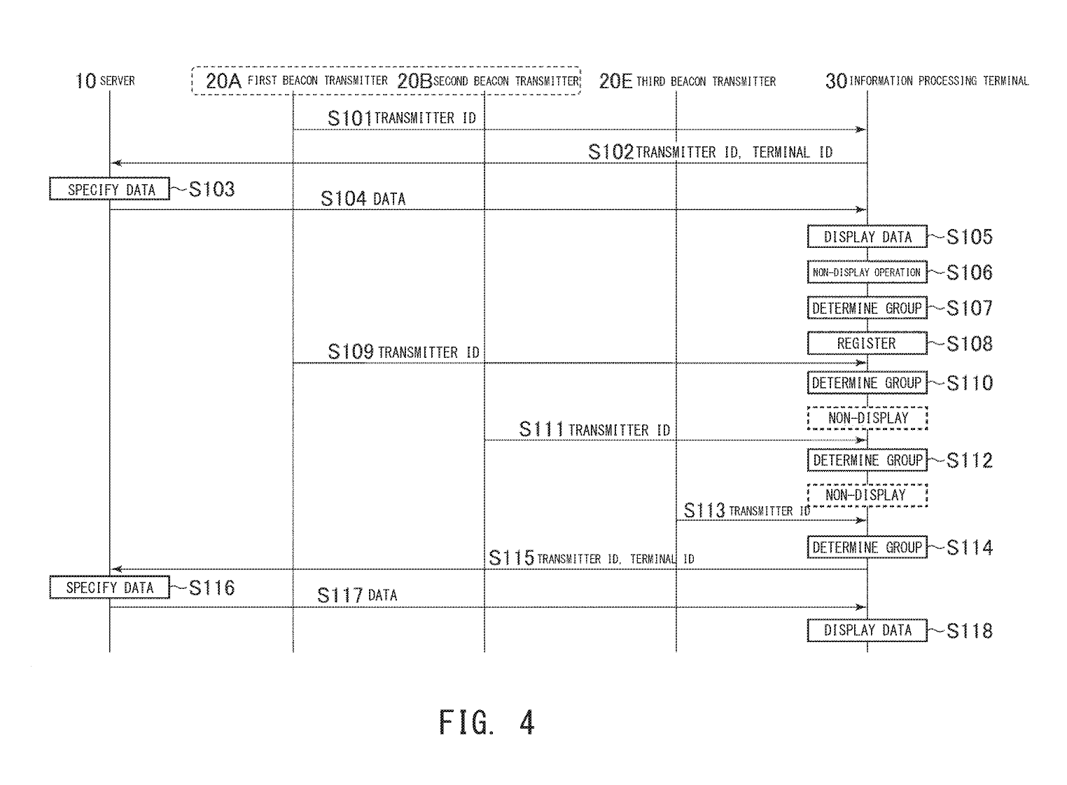

With reference to the sequence diagram shown in FIG. 4, the flow of processing in the case of the first example embodiment in the communication system 1 will be described. In the first example embodiment, when the restriction of display is entered by the user, the information processing terminal 30 determines whether the notification and display are needed at the time when the information processing terminal 30 receives the data.

First, the first beacon transmitter 20A transmits a transmitter ID (step S101).

Upon receiving the transmitter ID, the information processing terminal 30 transmits the received transmitter ID and the terminal ID of the information processing terminal 30 to the server 10 (step S102).

Upon receiving the transmitter ID, the server 10 specifies the data corresponding to the received transmitter ID (step S103). In addition, the server 10 transmits the specified data to the information processing terminal 30 specified by the terminal ID (step S104).

The information processing terminal 30 notifies reception of data by sound or vibration, and displays the received data on the display 36 (step S105). The data specified in step S103 and the data transmitted in step S104 may be identification information (for example, URL) of the data displayed in step S105. If the data is identification information, in step S105, the data is acquired using the identification information, and then displayed.

The information processing terminal 30 then accepts the non-display operation entered by the user (step S106). The information processing terminal 30 that has received the non-display data specifies the group in which the non-display is specified (step S107). For example, the data transmitted in step S104 may include information for specifying the group, or when the non-display operation is entered in step S106, information on the group may be acquired from the server 10.

In addition, the information processing terminal 30 registers the specified group as a group in which the data is not to be displayed (step S108). That is, the first group is set as a group in which the display of data is restricted.

The first beacon transmitter 20A then transmits the transmitter ID (step S109).

The information processing terminal 30 determines whether the first beacon transmitter 20A belongs to the group in which the display of data is restricted (step S110). The first beacon transmitter 20A belongs to the first group in which the display is restricted. Accordingly, the information processing terminal 30 does not execute reception notification and display of the data received in step S109 (“not displayed” in FIG. 4). The first beacon transmitter 20A may transmit the information specifying the group as well as the transmitter ID transmitted in step S109. Alternatively, the information processing terminal 30 may acquire information for specifying the group from the server 10 using the transmitter ID received in step S109.

In addition, the second beacon transmitter 20B transmits the transmitter ID (step S111).

The information processing terminal 30 determines whether the second beacon transmitter 20B belongs to the group in which the display of data is restricted (step S112). The second beacon transmitter 20B belongs to the first group in which the display is restricted. Accordingly, the information processing terminal 30 does not execute reception notification and display of the data received in step S112 (“not displayed” in FIG. 4). The second beacon transmitter 20B may include information specifying the group as well as the transmitter ID transmitted in step S111. Alternatively, the information processing terminal 30 may acquire information for specifying the group from the server 10 using the transmitter ID received in step S111.

Further, the third beacon transmitter 20E transmits the transmitter ID (step S113).

The information processing terminal 30 determines whether the third beacon transmitter 20E belongs to the group in which the display of data is restricted (step S114). The third beacon transmitter 20E does not belong to the group in which the display is restricted. Accordingly, the information processing terminal 30 transmits the received transmitter ID and the terminal ID of the information processing terminal 30 to the server 10 (step S115).

Upon receiving the transmitter ID, the server 10 specifies the data corresponding to the received transmitter ID (step S116). In addition, the server 10 transmits the specified data to the information processing terminal 30 specified by the terminal ID (step S117).

The information processing terminal 30 notifies the reception of data by sound or vibration, and displays the received data on the display 36 (step S118). The data specified in step S116 and the data transmitted in step S117 may be identification information (for example, URL) of the data displayed in step S118. If the data is identification information, in step S105, the data is acquired using the identification information, and then displayed.

Accordingly, the information processing terminal 30 does not notify and display reception of the data even if the information processing terminal 30 receives the data of the group registered by the user as a group in which the notification and display are not needed. Therefore, since the user is not forced to perform unnecessary operations, it is possible to comfortably use the communication system 1. Further, since the information processing terminal 30 need not acquire the data to be displayed from the information processor such as the server 10 every time the transmitter ID is received, it is possible to reduce the amount of communication by transmitting and receiving unnecessary data.

### <Second Example Embodiment (Determine Restriction of Display in Information Processing Terminal)>

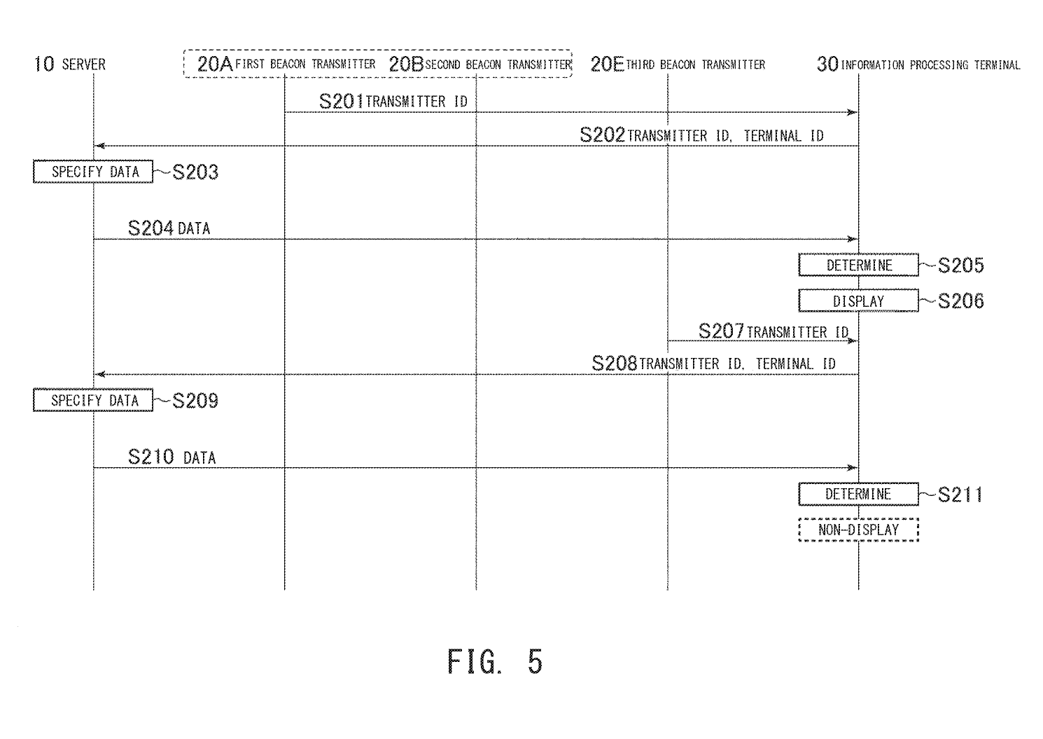

With reference to the sequence diagram shown in FIG. 5, the flow of processing in the case of the second example embodiment in the communication system 1 will be described. In the second example embodiment, the information processing terminal 30 determines whether display is needed at the time of receiving the data. Specifically, the information processing terminal 30 refers to the data stored in the operation history data 333 and determines whether the data needs to be displayed. Here, it is determined whether the operation “registered as friend” is performed as the operation history, and if the operation registered as friend is performed, the received data is notified and displayed. In the following description, the information processing terminal 30 determines that only the first group is “registered as friend.”

First, the first beacon transmitter 20A transmits the transmitter ID (step S201).

Upon receiving the transmitter ID, the information processing terminal 30 transmits the received transmitter ID and the terminal ID of the information processing terminal 30 to the server 10 (step S202).

Upon receiving the transmitter ID, the server 10 specifies the data corresponding to the received transmitter ID (step S203). In addition, the server 10 transmits the specified data to the information processing terminal 30 specified by the terminal ID (step S204). The data specified in step S203 and the data transmitted in step S204 may be data to be displayed by the information processing terminal 30 or may be identification information (for example, URL) of the data to be displayed. If the data is identification information, the information processing terminal 30 acquires the data by using the identification information at the time of displaying the data. Further, the data specified in step S203 and the data transmitted in step S204 include the ID of the group to which the first beacon transmitter 20A belongs.

The information processing terminal 30 determines whether an account ID or a group ID associated with the first beacon transmitter 20A is registered as a friend (step S205). The first beacon transmitter 20A belongs to the first group to be registered as a friend.

Accordingly, the information processing terminal 30 executes reception notification and display of the data received in step S204 (step S206).

The third beacon transmitter 20E then transmits the transmitter ID (step S207).

Upon receiving the transmitter ID, the information processing terminal 30 transmits the received transmitter ID and the terminal ID of the information processing terminal 30 to the server 10 (step S208).

Upon receiving the transmitter ID, the server 10 specifies the data corresponding to the received transmitter ID (step S209). In addition, the server 10 transmits the specified data to the information processing terminal 30 specified by the terminal ID (step S210). The data specified in step S203 and the data transmitted in step S204 include the data to be displayed by the information processing terminal 30 or identification information (for example, URL) of the data to be displayed, and the ID of the group to which the third beacon transmitter 20E belongs.

The information processing terminal 30 determines whether an account associated with the third beacon transmitter 20E is registered as a friend (step S211). The third beacon transmitter 20E does not belong to a group in which the account is registered as a friend.

Accordingly, the information processing terminal 30 does not execute reception notification and display of the data received in step S210 (“not displayed” in FIG. 5).

Accordingly, when the user receives data of the group in which the shop is registered as a friend, for example, the information processing terminal 30 notifies reception and displays the received data. It is considered that the user originally is interested in the shop registered as a friend. Accordingly, the user is not required to register non-display data, and it is possible to restrict notification of reception and display of the data. Since the user need not check unnecessary data, the user can comfortably use the communication system 1.

### <Third Example Embodiment (Determination of Restriction of Display in Server)>

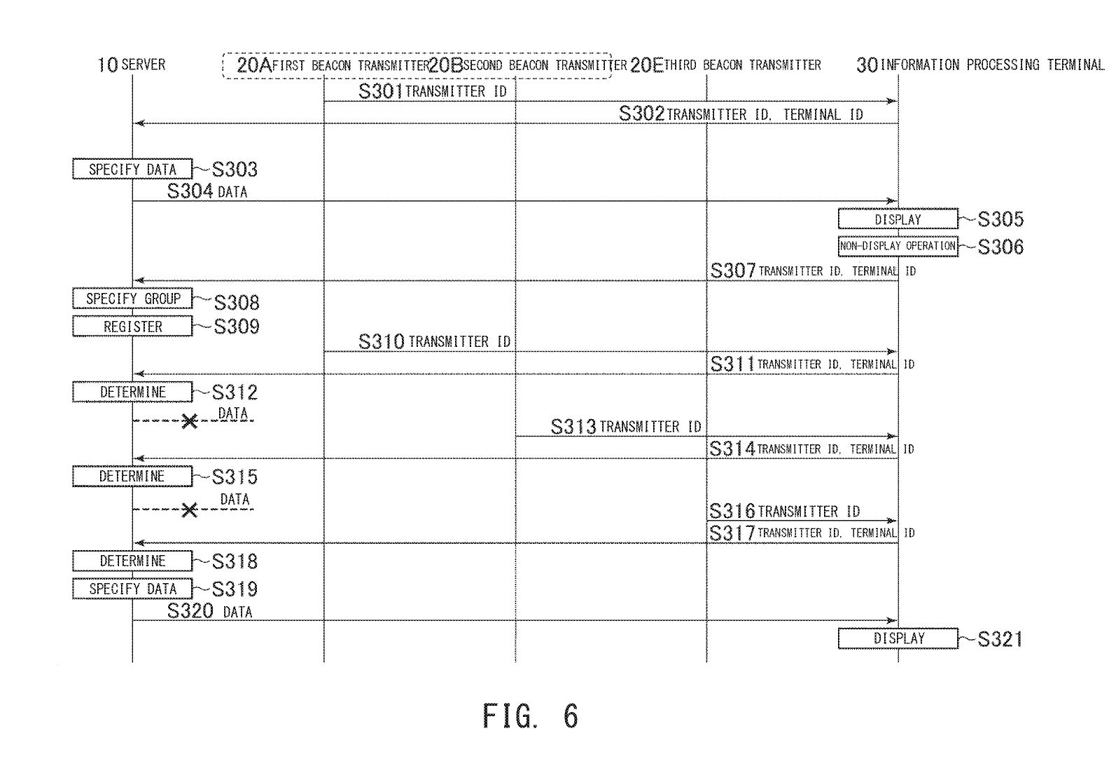

With reference to the sequence diagram shown in FIG. 6, the flow of processing in the case of the third example embodiment in the communication system 1 will be described. In the third example embodiment, when the restriction of display is entered by the user, the server 10 determines whether the data is to be displayed on the information processing terminal 30. In the present example embodiment, the terminal ID may include an account identifier associated with the information processing terminal 30.

First, the first beacon transmitter 20A transmits the transmitter ID (step S301).

Upon receiving the transmitter ID, the information processing terminal 30 transmits the received transmitter ID and the terminal ID of the information processing terminal 30 to the server 10 (step S302).

Upon receiving the transmitter ID, the server 10 specifies the data corresponding to the received transmitter ID (step S303). In addition, the server 10 transmits the specified data to the information processing terminal 30 specified by the terminal ID (step S304).

The information processing terminal 30 notifies the reception of the data and displays the received data on the display 36 (step S305). The data specified in step S303 and the data transmitted in step S304 may be identification information (for example, URL) of the data displayed in step S305. If the data is identification information, in step S305, the data is acquired using the identification information, and then displayed.

The information processing terminal 30 then accepts the non-display operation entered by the user (step S306). The information processing terminal 30 which receives the non-display data transmits a non-display request signal including the transmitter ID and the terminal ID (step S307).

Upon receiving the non-display request signal, the server 10 specifies the group to which the device of the transmitter ID included in the non-display request signal belongs (step S308). Also, the server 10 registers the specified group as a non-display target group in association with the terminal ID (step S309). That is, the first group is set as a group in which the display of data is restricted.

The first beacon transmitter 20A then transmits the transmitter ID (step S310).

Upon receiving the transmitter ID, the information processing terminal 30 transmits the transmitter ID received in step S310 and the terminal ID of the information processing terminal 30 to the server 10 (step S311).

The server 10 determines whether the first beacon transmitter 20A belongs to the group in which the display of data is restricted (step S312). The first beacon transmitter 20A belongs to the first group in which the display is restricted. As a result, the server 10 does not transmit the data corresponding to the transmitter ID transmitted in step S311 to the information processing terminal 30 (broken line in FIG. 6). Accordingly, the information processing terminal 30 does not execute reception notification and display of the data.

In addition, the second beacon transmitter 20B transmits the transmitter ID (step S313).

Upon receiving the transmitter ID, the information processing terminal 30 transmits the transmitter ID received in step S313 and the terminal ID of the information processing terminal 30 to the server 10 (step S314).

The server 10 determines whether the second beacon transmitter 20B belongs to a group in which the display of data is restricted (step S112). The second beacon transmitter 20B belongs to the first group in which the display is restricted. As a result, the server 10 does not transmit the data corresponding to the transmitter ID transmitted in step S314 to the information processing terminal 30 (broken line in FIG. 6). Accordingly, the information processing terminal 30 does not execute reception notification and display of the data.

Further, the third beacon transmitter 20E transmits the transmitter ID (step S316).

Upon receiving the transmitter ID, the information processing terminal 30 transmits the transmitter ID received in step S316 and the terminal ID of the information processing terminal 30 to the server 10 (step S317).

The server 10 determines whether the third beacon transmitter 20E belongs to a group in which the display of data is restricted (step S318). The third beacon transmitter 20E does not belong to the group in which the display is restricted.

Accordingly, the server 10 specifies the data corresponding to the transmitter ID (step S319). In addition, the server 10 transmits the specified data to the information processing terminal 30 specified by the terminal ID (step S320).

Upon receiving the data in step S320, the information processing terminal 30 executes reception notification and display (step S321).

Accordingly, the information processing terminal 30 does not notify and display reception of the data even if the information processing terminal 30 receives the data of the group registered by the user as a group in which the notification and display are not needed. Therefore, since the user is not forced to perform unnecessary operations, it is possible to comfortably use the communication system 1. In addition, since the server 10 need not transmit the data to the information processing terminal 30 each time the transmitter ID of the information processing terminal 30 is received, it is also possible to reduce the amount of communication due to transmission and reception of unnecessary data.

### <Fourth Example Embodiment (Determine Restriction of Display in Server)>

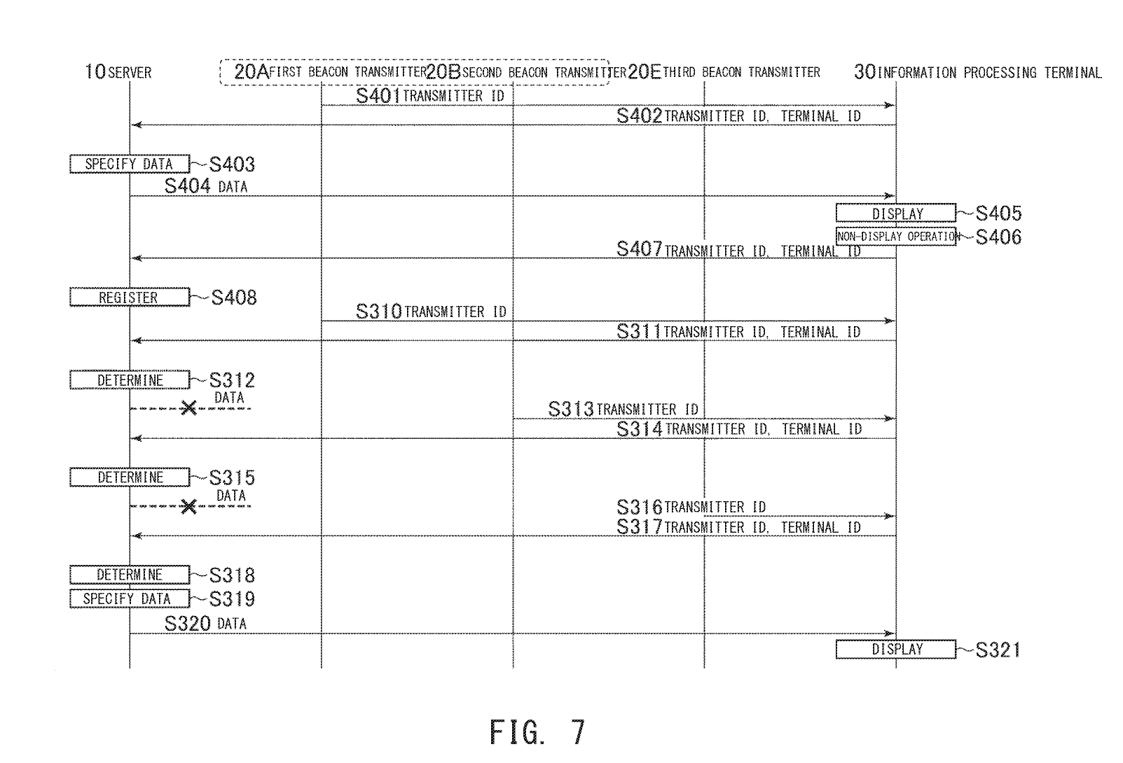

With reference to the sequence diagram shown in FIG. 7, the flow of processing in the case of the fourth example embodiment in the communication system 1 will be described. In the fourth example embodiment, when the restriction of display is entered by the user, the server 10 determines whether the data is to be displayed on the information processing terminal 30. In the present example embodiment, the terminal ID may include an account identifier associated with the information processing terminal 30.

First, the first beacon transmitter 20A transmits the transmitter ID (step S401).

Upon receiving the transmitter ID, the information processing terminal 30 transmits the received transmitter ID and the terminal ID of the information processing terminal 30 to the server 10 (step S402).

Upon receiving the transmitter ID, the server 10 specifies the data corresponding to the received transmitter ID (step S403). Further, the server 10 transmits the specified data to the information processing terminal 30 specified by the terminal ID (step S404).

The information processing terminal 30 notifies the reception of the data and displays the received data on the display 36 (step S405). The data specified in step S403 and the data transmitted in step S404 may be identification information (for example, URL) of the data displayed in step S405. If the data is identification information, in step S405, the data is acquired using the identification information, and then displayed. The data specified in step S403 and the data transmitted in step S404 include an account ID corresponding to the first beacon transmitter 20A or an ID of a group to which the first beacon transmitter 20A belongs.

The information processing terminal 30 then accepts the non-display operation entered by the user (step S406). The information processing terminal 30 that accepts the non-display data transmits a non-display request signal including the account ID or the group ID, and the terminal ID (step S407).

Upon receiving the non-display request signal, the server 10 registers the group specified by the account ID or the group ID included in the non-display request signal as the non-display target group (step S408). That is, the first group is set as a group in which the display of data is restricted.

The subsequent processing is the same as steps S310 to S321 above with reference to FIG. 6, and thus the same reference numerals are given and descriptions thereof are omitted.

Accordingly, the information processing terminal 30 does not notify and display reception of the data even if the information processing terminal 30 receives the data of the group registered by the user as a group in which the notification and display are not needed. Therefore, since the user is not forced to perform unnecessary operations, it is possible to comfortably use the communication system 1. In addition, since the server 10 need not transmit the data to the information processing terminal 30 each time the transmitter ID of the information processing terminal 30 is received, it is also possible to reduce the amount of communication due to transmission and reception of unnecessary data.

### <Fifth Example Embodiment (Determine Restriction of Display in Server)>

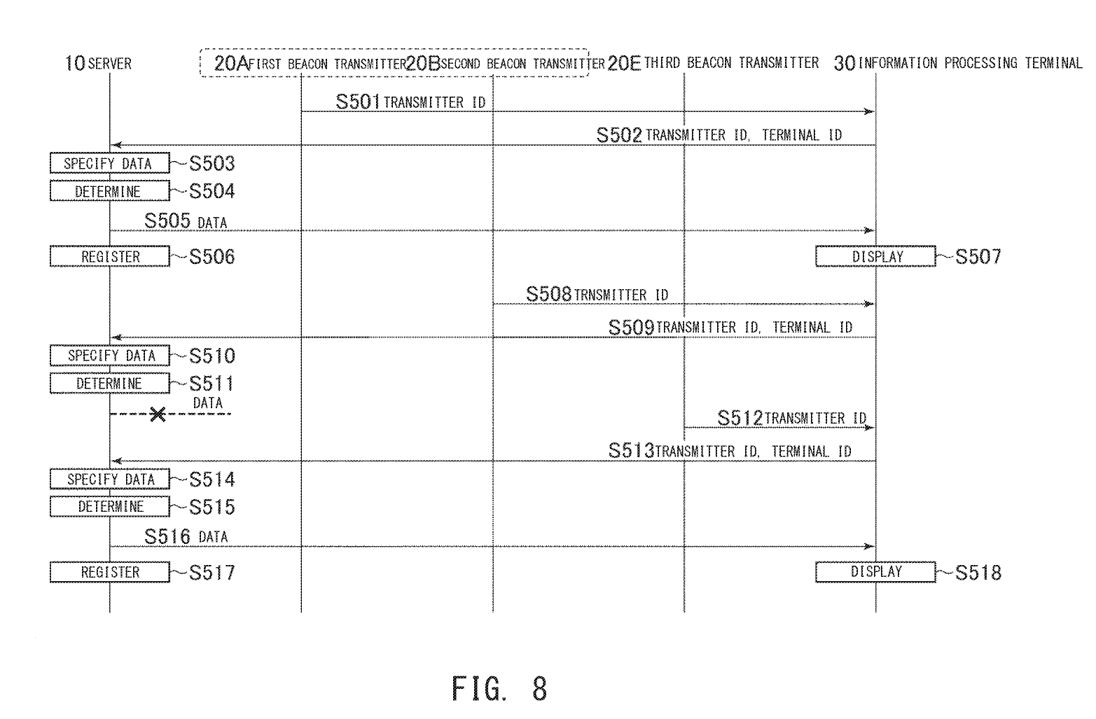

With reference to the sequence diagram shown in FIG. 8, the flow of processing in the case of the fifth example embodiment in the communication system 1 will be described. In the fifth example embodiment, when the restriction of display is entered by the user, the server 10 determines whether the data is to be displayed on the information processing terminal 30.

First, the first beacon transmitter 20A transmits the transmitter ID (step S501).

Upon receiving the transmitter ID, the information processing terminal 30 transmits the received transmitter ID and the terminal ID of the information processing terminal 30 to the server 10 (step S502).

Upon receiving the transmitter ID, the server 10 specifies the data corresponding to the received transmitter ID (step S503).

Upon specifying the data in step S503, the server 10 determines whether the data is to be transmitted by determining whether the specified data has been transmitted to the information processing terminal 30 in the past (step S504). Specifically, the server 10 refers to the transmission history data in which the ID of the information processing terminal as the destination of the data and the group ID corresponding to the data transmitted to the information processing terminal are associated with each other, and determines whether the terminal ID received in step S502 is associated with the group ID corresponding to the data specified in step S503. Further, if the terminal ID and the group ID are not associated with each other, the server 10 determines that the data is to be transmitted.

Upon determining that the data is to be transmitted, the server 10 transmits the data specified in step S503 to the information processing terminal 30 specified by the terminal ID received in step S502 (step S505).

As the server 10 determines that the data is to be transmitted, the server 10 registers the terminal ID and the group ID in the transmission history data in association with each other (step S506). Specifically, the server 10 registers the terminal ID of the information processing terminal 30 and the ID of the first group in the transmission history data.

The information processing terminal 30 notifies the reception of the data and displays the received data on the display 36 (step S507). The data specified in step S503 and the data transmitted in step S505 may be identification information (for example, URL) of the data displayed in step S507. If the data is identification information, in step S507, the data is acquired using the identification information, and then displayed.

The second beacon transmitter 20B then transmits the transmitter ID (step S508).

Upon receiving the transmitter ID, the information processing terminal 30 transmits the transmitter ID received in step S508 and the terminal ID of the information processing terminal 30 to the server 10 (step S509).

Upon receiving the transmitter ID, the server 10 specifies the data corresponding to the received transmitter ID (step S510).

As the server 10 specifies the data in step S510, the server 10 determines whether the data is to be transmitted (step S511). In the transmission history data, the ID of the information processing terminal 30 and the ID of the first group to which the second beacon transmitter 20B belongs are associated with each other. Accordingly, the server 10 determines that the data specified in step S510 is not to be transmitted. As a result, the server 10 does not transmit the data corresponding to the transmitter ID transmitted in step S509 to the information processing terminal 30 (broken line in FIG. 8). Accordingly, the information processing terminal 30 does not execute reception notification and display of the data.

In addition, the third beacon transmitter 20E transmits the transmitter ID (step S512).

Upon receiving the transmitter ID, the information processing terminal 30 transmits the transmitter ID received in step S512 and the terminal ID of the information processing terminal 30 to the server 10 (step S513).

Upon receiving the transmitter ID, the server 10 specifies the data corresponding to the received transmitter ID (step S514).

Upon specifying the data in step S514, the server 10 determines whether the data is to be transmitted (step S515). In the transmission history data, the ID of the information processing terminal 30 and the group ID to which the third beacon transmitter 20E belongs are not associated with each other. Accordingly, the server 10 determines that the data specified in step S510 is to be transmitted.

The server 10 transmits the data specified in step S514 to the information processing terminal 30 specified by the terminal ID (step S516).

As the server 10 determines that the data is to be transmitted, the server 10 registers the terminal ID and the group ID in the transmission history data in association with each other (step S517). Specifically, the server 10 registers the terminal ID of the information processing terminal 30 and the ID of the group to which the third beacon transmitter 20E belongs in the transmission history data.

Upon receiving the data in step S320, the information processing terminal 30 executes reception notification and display (step S321).

Accordingly, the information processing terminal 30 does not notify and display reception of the data even if the information processing terminal 30 receives the data of the group registered by the user as a group in which the notification and display are not needed. Therefore, since the user is not forced to perform unnecessary operations, it is possible to comfortably use the communication system 1. In addition, since the server 10 need not transmit the data to the information processing terminal 30 each time the transmitter ID of the information processing terminal 30 is received, it is also possible to reduce the amount of communication due to transmission and reception of unnecessary data.

The example embodiments above are described to be embodied by the CPU 31 of the information processing terminal 30 executing the display program P. In contrast, in the information processing terminal 30, the processing may be embodied not only by the CPU 31 but also by a logic circuit (hardware) or a dedicated circuit formed in an integrated circuit (IC) chip and a large scale integration (LSI), for example. In addition, these circuits may be achieved by one or more integrated circuits, and a plurality of functions described in the example embodiments above may be achieved by a single integrated circuit. LSIs are sometimes referred to as VLSI, Super LSI, Ultra LSI, for example, depending on the difference in integration degree.

Also, the display program P according to at least one example embodiment may be provided in a state in which the program P is stored in a non-transitory computer readable storage medium. The storage medium may include a semiconductor storage device such as a read only memory (ROM), a random access memory (RAM), a compact flash (CF), a secure digital (SD); a magnetic storage medium such as a flexible disk; and an optical storage medium such as a compact disk read only memory (CD-ROM), for example. The storage medium is not limited to these examples, and any device or medium may be used as long as the display program P can be stored. The information processing terminal (for example, the information processing terminal 30) reads out the display program P stored in the storage medium, for example, and executes the read display program P to embody the functions of the plurality of functional units illustrated in the example embodiments above. Further, the display program P of at least one example embodiment may be provided to the information processing terminal 30 by being downloaded via the Internet, for example. The information processing terminal (for example, the information processing terminal 30) executes the display program P downloaded via the Internet, for example, to embody the functions of the plurality of functional units illustrated in the example embodiments above.

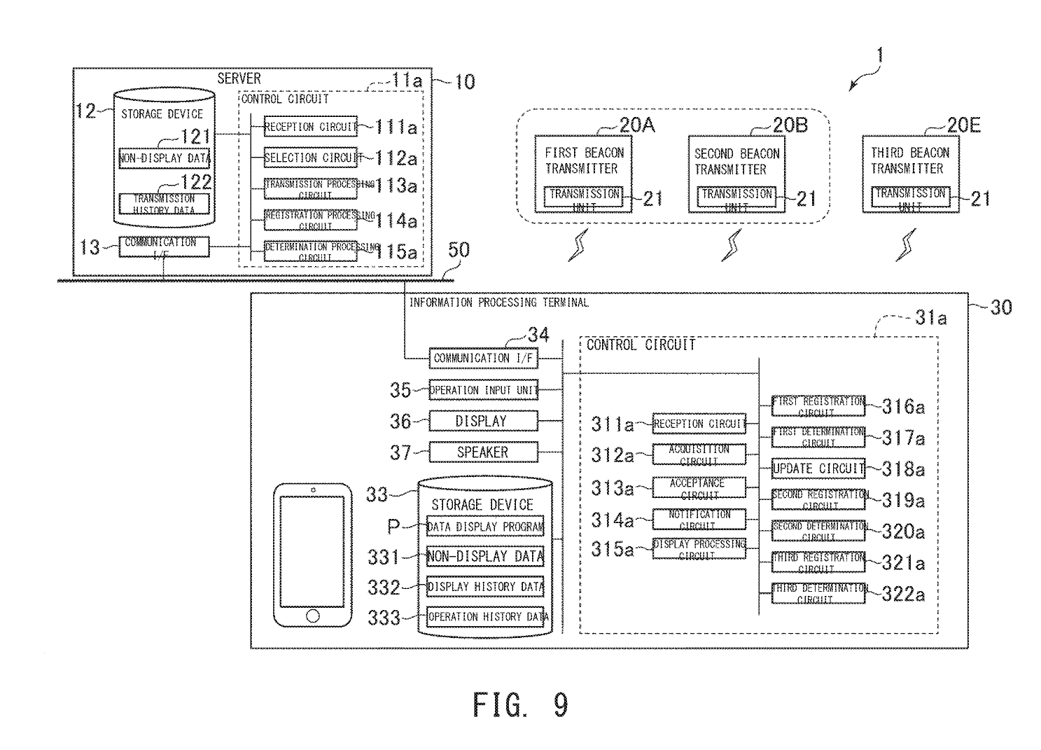

Specifically, as shown in FIG. 9, the information processing terminal 30 may be configured by a control circuit 31a having a reception circuit 311a, an acquisition circuit 312a, an acceptance circuit 313a, a notification circuit 314a, a display processing circuit 315a, a first registration circuit 316a, a first determination circuit 317a, an update circuit 318a, a second register circuit 319a, a second determination circuit 320a, a third registration circuit 321a and a third determination circuit 322a; a storage device 33 for storing the display program P, for example; a communication I/F 34; an operation input unit 35; a display 36; and a speaker 37. The functions of these elements are the same as those of the portions having the same names as illustrated in the example embodiment above.

### LIST OF REFERENCE NUMBERS COMMUNICATION SYSTEM

10 server

111 receiver

112 selection section

113 transmission processor

114 registration processor

115 determination processor

121 non-display data

122 terminal data

123 related data

20 (20A, 20B, 20E) beacon transmitter

30 information processing terminal

311 receiver

312 acquisition unit

313 acceptance unit

314 notifier

315 display processor

316 first register

317 first determination unit

318 update unit

319 second register

320 second determination unit

321 third register

322 third determination unit

331 non-display data

332 display history data

333 operation history data

P display program

What is claimed is:

1. A data display method in an information processing terminal, the method comprising:
receiving, using at least one processor, transmitter identification information of a transmitter from the transmitter;
acquiring, using the at least one processor, data associated with the transmitter identification information;
determining, using the at least one processor, whether display of the data associated with the transmitter identification information is to be restricted;
displaying, using the at least one processor, the data corresponding to the transmitter identification information based on results of the determining,; and
accepting, using the at least one processor, designation for restricting display of the data in response to an operation by a user.

2. The data display method according to claim 1, wherein the data is associated with two or more pieces of the transmitter identification information.

3. The data display method according to claim 1, further comprising:
transmitting the transmitter identification information and a port number or an IP address associated with the information processing terminal to a server.

4. The data display method according to any one of claims 1, wherein the accepting includes the designation for restricting display of the data according to the operation by the user, the operation designating a group associated with the transmitter identification information.

5. The data display method according to any one of claims 1, further comprising:
registering, using the at least one processor, a group associated with the transmitter identification information designated as a non-display target, wherein,
the displaying includes, displaying the data associated with the transmitter identification information in response to a group associated with the transmitter identification information of the transmitter not being included in the non-display target as the transmitter identification information is newly received.

6. The data display method according to claim 4, further comprising:
updating, using the at least one processor, a non-display target, the updating including canceling the restriction of display of a group after the group in which the display is restricted is designated.

7. The data display method according to claim 1, further comprising:
registering, using the at least one processor, a group corresponding to the data as display history data in response to the data being displayed, wherein
the data associated with the transmitter identification information is displayed in response to a group associated with the transmitter identification information not being included in the display history data as transmitter identification information is newly received.

8. The data display method according to claim 7, wherein
the display history data further includes a display time at which the data is displayed; and
in response to a desired time period has elapsed from the display time at which the data corresponding to the group was displayed, the data corresponding to the group is displayed even when the group is included in a non-display target.

9. The data display method according to claim 7, further comprising:
determining, using the at least one processor, whether an operation related to the data associated with the transmitter identification information is included in operation history data of the user as transmitter identification information is newly received.

10. A non-transitory computer readable medium storing computer readable instructions, which when executed by at least one processor of an information processing terminal, cause the at least one processor to:
receive transmitter identification information corresponding to a transmitter;
acquire data associated with the transmitter identification information;
determine whether display of the data associated with the transmitter identification information is to be restricted;
display, the data corresponding to the transmitter identification information in response to a group in which display is restricted is not designated for the data associated with transmitter identification information; and
accept designation for restricting display of the data in response to an operation by a user.

11. A communication system comprising:
a memory having computer readable instructions stored thereon; and
at least one processor configured to execute the computer readable instructions to,
transmit identification information of an own device using a transmitter, the identification information corresponding to a group including a plurality of transmitters;
transmit data associated with the group corresponding to the identification information in response to a request;
receiving the transmitter identification information of the transmitter of the plurality of transmitters;
acquiring data associated with the transmitter identification information;
determining whether display of the data associated with the group is to be restricted;
displaying the data corresponding to the transmitter identification information based on results of the determining; and
accepting designation of the group for restricting display of the data associated with the group in response to an operation by a user.

12. The communication system according to claim 11, wherein the at least one processor is further configured to:
register identification information of the group designated as non-display data; and
determine whether the data corresponding to identification information of the group is to be displayed, in response to a group in which display of data is restricted is not designated is identified by the newly received transmitter identification information.

13. The communication system according to claim 11, wherein the at least one processor is further configured to:
notify a user of the identification information of the designated group ; and
register the identification information of the group as non-display data, wherein
in response to a request signal is newly received, the request signal indicating the transmitter identified by the identification information is not included in the group in which the identification information is registered in the non-display data, the data is transmitted.

14. An information processing terminal comprising:
a memory having computer readable instructions stored thereon; and
at least one processor configured to execute the computer readable instructions to,
receive transmitter identification information of a transmitter;
acquire data associated with the transmitter identification information;
determine whether display of the data associated with the transmitter identification information is to be restricted;
display, the data corresponding to the transmitter identification information based on results of the determining; and
accept designation for restricting display of the data according to an operation by a user.
